(19) United States
(12) Patent Application Publication
(10) Pub. No.: US 2026/0303212 A1
(43) Pub. Date: Oct. 1, 2026

(54) OPTICAL SYSTEM CONTROL DEVICE, OPTICAL SYSTEM CONTROL METHOD, AND RECORDING MEDIUM

(71) Applicant: NEC Corporation, Tokyo (JP)

(72) Inventors: Tatsuro MAKI, Tokyo (JP); Akihiko Kato, Tokyo (JP); Tadayoshi Inumaru, Tokyo (JP)

(73) Assignee: NEC Corporation, Tokyo (JP)

(21) Appl. No.: 19/563,596

(22) Filed: Mar. 11, 2026

(30) Foreign Application Priority Data
Mar. 26, 2025 (JP) 2025-051053

(51) Int. Cl. H04B 10/11; G02B 27/00; H04B 10/80

(52) U.S. Cl. CPC H04B 10/11; G02B 27/0012; H04B 10/80

(57) ABSTRACT

An optical system control device according to the disclosure is configured to execute: acquiring observation data of light from a target object in an atmospheric condition at a certain time, inputting observation data of the light to a model that has learned observation results of the light under a plurality of atmospheric conditions as training data, and a controlling adaptive optics in such a way as to cancel an effect of disturbance of laser light due to an influence of atmospheric turbulence in the atmospheric condition at the certain time based on an output result from the model.

This application is based upon and claims the benefit of priority from Japanese patent application No. 2025-051053, filed on March 26, 2025, the disclosure of which is incorporated herein in its entirety by reference.

### TECHNICAL FIELD

The present disclosure relates to an optical system control device, an optical system control method, and a recording medium, and relates to an optical system control device that controls an optical system of a communication system, an optical system control method, and a recording medium.

### BACKGROUND ART

A related optical compensation system described in PTL 1 (WO 2020/100360 A) includes wavefront correction optics, a sensor, and a controller. The wavefront correction optics correct a wavefront of light passing through a predetermined optical path. The sensor acquires environmental information in the optical path. The controller predicts wavefront disturbance of the light passing through the optical path based on the environmental information, and controls wavefront adaptive optics (AO) in such a way as to cancel the predicted wavefront disturbance. As a result, the related optical compensation system performs optical correction based on a result of artificial intelligence (AI) learning performed in advance using learning data including measurement data.

### SUMMARY

In the related technology, there is a possibility (of beam wander) that laser communication is interrupted due to a change in intensity of laser light or a change in an arrival angle of laser light to an opposite station (receiving station) due to factors such as atmospheric turbulence.

The present disclosure has been made in view of the above problem, and an object thereof is to reduce disturbance of laser light due to an influence of atmospheric turbulence.

An optical system control device according to an aspect of the present disclosure includes an acquisition means for acquiring observation data of light from a target object in an atmospheric condition at a certain time, an input means for inputting the observation data of the light to a model that has learned observation results of the light under a plurality of the atmospheric conditions as training data, and a control means for controlling adaptive optics in such a way as to cancel an effect of disturbance of laser light due to an influence of atmospheric turbulence in the atmospheric condition at the certain time based on an output result from the model.

In an optical system control method according to an aspect of the present disclosure, a computer executes a step of acquiring observation data of light from a target object in an atmospheric condition at a certain time, a step of inputting the observation data of the light to a model that has learned observation results of the light under a plurality of the atmospheric conditions as training data, and a step of controlling adaptive optics in such a way as to cancel an effect of disturbance of laser light due to an influence of atmospheric turbulence in the atmospheric condition at the certain time based on an output result from the model.

A recording medium according to an aspect of the present disclosure stores a program for causing a computer to execute processing of acquiring observation data of light from a target object in an atmospheric condition at a certain time, processing of inputting the observation data of the light to a model that has learned observation results of the light under a plurality of the atmospheric conditions as training data, and processing of controlling adaptive optics in such a way as to cancel an effect of disturbance of laser light due to an influence of atmospheric turbulence in the atmospheric condition at the certain time based on an output result from the model.

According to one aspect of the present disclosure, it is possible to reduce the disturbance of the laser light due to the influence of the atmospheric turbulence.

### BRIEF DESCRIPTION OF THE DRAWINGS

FIG. 1 is a diagram schematically illustrating an example of a system according to one example embodiment;

FIG. 2 is a diagram illustrating a method for canceling an effect of disturbance of laser light due to an influence of atmospheric turbulence using adaptive optics (AO);

FIG. 3 is a block diagram illustrating a configuration of an optical system control device according to one example embodiment;

FIG. 4 is a flowchart illustrating an operation of the optical system control device according to the example embodiment;

FIG. 5 is a block diagram illustrating a configuration of an optical system control device according to one example embodiment;

FIG. 6 is a diagram illustrating an example of a method for training a model of machine learning using training data (observation results and observation parameters of sunlight under a plurality of atmospheric conditions);

FIG. 7 is a flowchart illustrating an operation of the optical system control device according to the example embodiment;

FIG. 8 is a diagram illustrating a method for increasing the training data (wavefront data & observation parameters) for the model to learn by using the adaptive optics;

FIG. 9 is a flowchart illustrating an operation of the optical system control device according to the example embodiment; and

FIG. 10 is a diagram illustrating an example of a hardware configuration of an information processing device according to one example embodiment.

### EXAMPLE EMBODIMENT

Hereinafter, some example embodiments of the present disclosure will be described with reference to the drawings.

### FIRST EXAMPLE EMBODIMENT

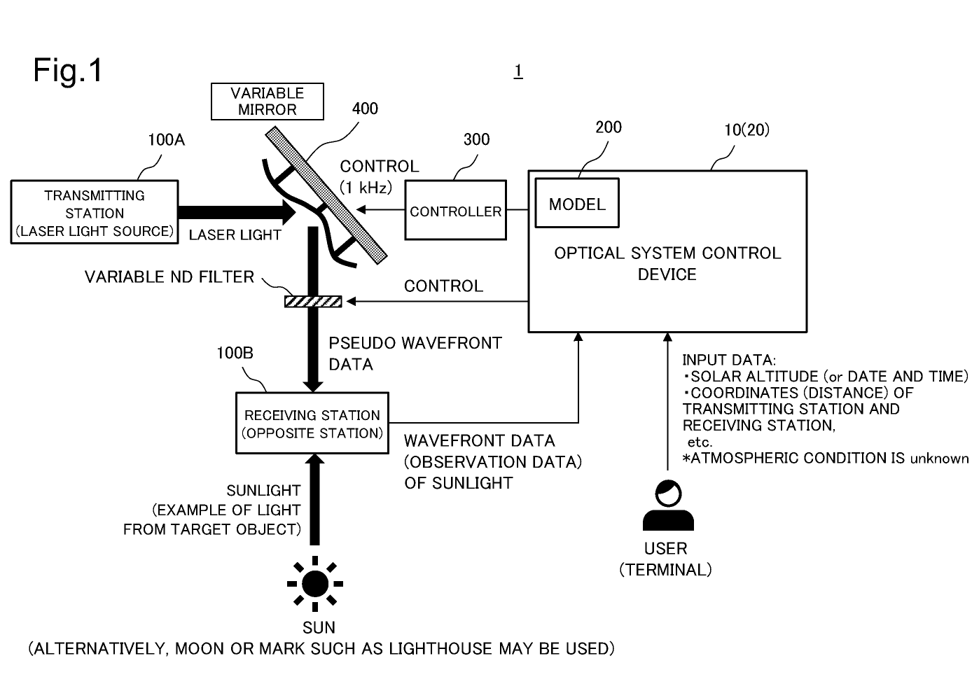

A first example embodiment of the present disclosure will be described with reference to FIGS. 1 to 4.

### EXAMPLE OF COMMUNICATION SYSTEM 1

FIG. 1 is a diagram schematically illustrating an example of a communication system 1 according to the first example embodiment of the present disclosure. As illustrated in FIG. 1, the communication system 1 includes an optical system control device 10 (20), a transmitting station (laser light source) 100A, a model 200, a controller 300, and a receiving station (opposite station) 100B. The optical system control device 10 (20) may include the model 200. Here, the “optical system control device 10 (20)” means “the optical system control device 10 according to the first example embodiment or the optical system control device 20 according to a second example embodiment to be described later”.

The communication system 1 includes the transmitting station (laser light source) 100A and the receiving station (opposite station) 100B. The model 200 is a program trained using a large-scale data set (training data) for a certain task by a technology such as deep learning.

Here, the training data is wavefront data (referred to as “observation data”) of light from a target object observed under various observation conditions. When observation data of light from a target object observed under a certain observation condition is set (input), the model 200 is trained in advance to output pseudo wavefront data of laser light predicted to be observed under the certain observation condition. Hereinafter, a case where the target object is the sun and the light from the target object is sunlight will be described as an example. However, the target object is not limited to the sun, and may be, for example, the moon or a light source serving as a mark such as a lighthouse.

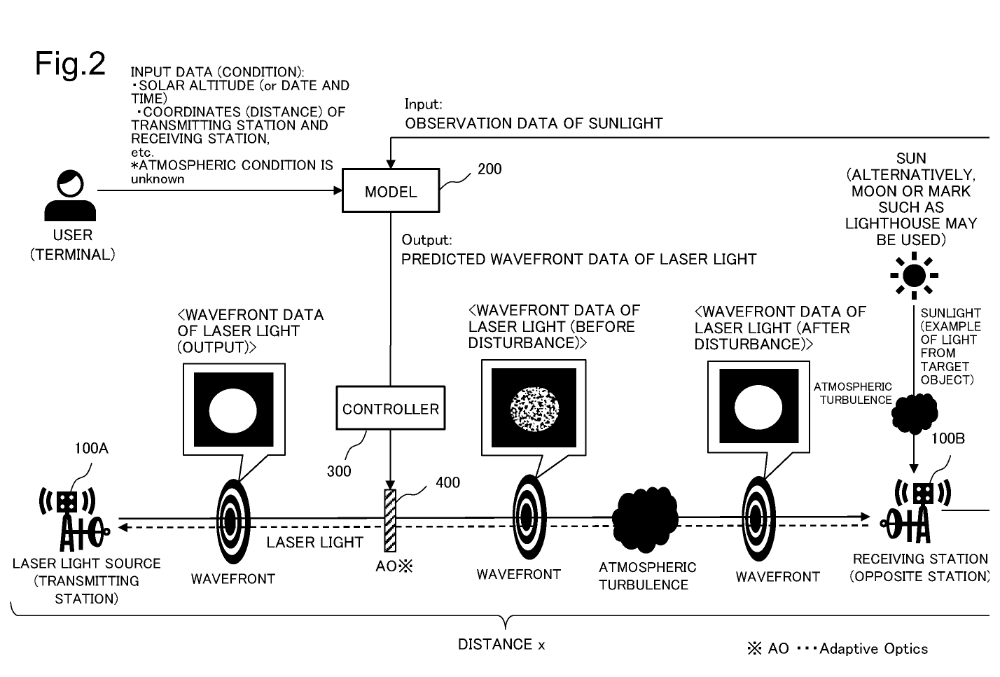

The observation conditions here include a solar altitude at an observation time or a date and time of the observation time, and coordinates (distance x) (FIG. 2) of the transmitting station 100A (FIG. 1) and the receiving station 100B (FIG. 1).

### METHOD FOR CANCELING EFFECT OF DISTURBANCE OF LASER LIGHT DUE TO INFLUENCE OF ATMOSPHERIC TURBULENCE

With reference to FIG. 2, a method in which the optical system control device 10 (20) cancels an effect of disturbance of laser light due to an influence of atmospheric turbulence using adaptive optics 400 will be described.

First, a user inputs the observation conditions such as the solar altitude (or the date and time of the observation time) and the distance x between the transmitting station 100A and the receiving station 100B to the trained model 200 using a user terminal.

The receiving station (opposite station) 100B outputs wavefront data (hereinafter, referred to as “observation data”) of sunlight affected by the atmospheric turbulence in an atmospheric condition at a certain time (hereinafter referred to as the “observation time”) in the vicinity of the receiving station 100B. The observation data is, for example, a moving image of about several tens of seconds in which a wavefront of the sunlight is captured.

The receiving station 100B transmits the generated observation data of the sunlight to the trained model 200.

The model 200 outputs wavefront data of laser light predicted (at the observation time of the sunlight) based on the observation data of the sunlight received from the receiving station 100B and the observation conditions input from the user terminal. The predicted wavefront data of the laser light is a moving image of about several tens of seconds representing a pseudo wavefront of the laser light affected by the atmospheric turbulence.

The model 200 outputs the wavefront data (FIG. 2) of the laser light predicted from the input observation data of the sunlight to the controller 300.

Based on the wavefront data of the laser light received from the model 200, the controller 300 controls the adaptive optics 400 in such a way as to cancel the influence of the atmospheric turbulence (disturbance of the laser light) expected to affect the laser light. The adaptive optics 400 include, for example, a Shack-Hartmann wavefront sensor and a variable mirror (FIG. 1).

In other words, if laser light is output from the receiving station 100B (a dashed arrow in FIG. 2), the controller 300 controls the adaptive optics 400 in such a way as to reproduce a state before a wavefront of the laser light via the adaptive optics 400 is affected by the atmospheric turbulence. As a result, “wavefront data (before disturbance) of laser light” illustrated in FIG. 2 is obtained.

Thereafter, the wavefront of the laser light directed rightward in FIG. 2 (a solid arrow in FIG. 2) is disturbed under the influence of the atmospheric turbulence, but a state of the wavefront of the laser light after the disturbance is the same as a state of the wavefront of the laser light immediately after being output from the transmitting station 100A (FIG. 2). This is because an effect of the adaptive optics 400 (the variable mirror and the like) and the influence of the atmospheric turbulence cancel each other out.

In this manner, the receiving station (opposite station) 100B observes “wavefront data (after disturbance) of laser light” illustrated in FIG. 2. The “wavefront data (after disturbance) of laser light” illustrated in FIG. 2 is at least theoretically equal to the “wavefront data (output) of laser light”.

### CONFIGURATION OF OPTICAL SYSTEM CONTROL DEVICE 10

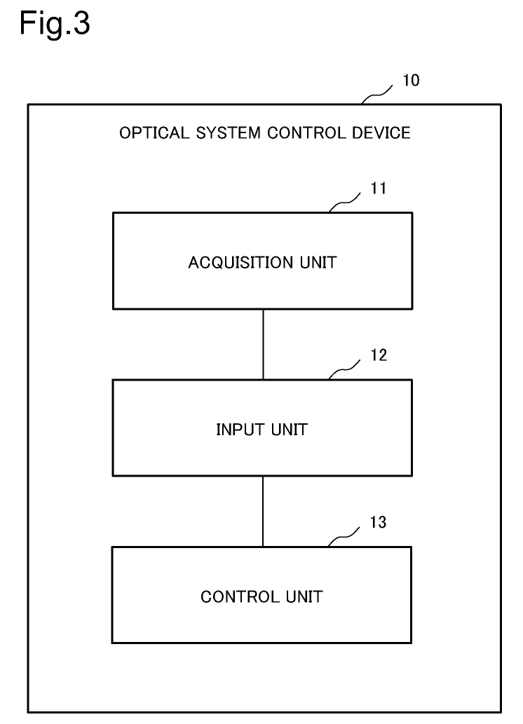

FIG. 3 is a block diagram illustrating a configuration of the optical system control device 10 according to the first example embodiment. As illustrated in FIG. 3, the optical system control device 10 includes an acquisition unit 11, an input unit 12, and a control unit 13.

The acquisition unit 11 acquires observation data which is wavefront data of sunlight observed at an observation time and is to be input to the trained model 200 (FIG. 1). The acquisition unit 11 is an example of an acquisition means.

For example, the acquisition unit 11 acquires the observation data of the sunlight from the receiving station 100B(FIGS. 1 and 2). In one example, the observation data of the sunlight is a moving image of about several tens of seconds in which a wavefront of the sunlight during the observation time is captured. The acquisition unit 11 outputs the acquired observation data to the input unit 12.

The input unit 12 inputs the observation data of the sunlight acquired by the acquisition unit 11 to the model 200 that has learned observation results (a set of pieces of observation data) of the sunlight under a plurality of atmospheric conditions as training data. The input unit 12 is an example of an input means. An example of a learning method of the model 200 will be described in the second example embodiment to be described later.

For example, the input unit 12 receives the observation data of the sunlight from the acquisition unit 11.

In addition, the input unit 12 receives an observation condition as input data from the user terminal (FIGS. 1 and 2). For example, the observation condition is a solar altitude, a date and time (a period or a time point) of the observation time, or coordinates (the distance x) (FIG. 2) of the transmitting station 100A (FIG. 1) and the receiving station 100B (FIG. 2).

The input unit 12 outputs the received observation data and, if any, the input data (observation condition) from the user terminal to the control unit 13.

Based on an output result from the model 200, the control unit 13 controls the adaptive optics 400 in such a way as to cancel an effect of disturbance of laser light due to an influence of atmospheric turbulence in an atmospheric condition during the observation time (FIG. 2). The control unit 13 is an example of a control means.

Specifically, based on the output result from the model 200, the control unit 13 controls the adaptive optics 400 in such a way as to generate a simulated conjugate wavefront (phase conjugate wave) that brings a wavefront of the laser light, disturbed by the influence of the atmospheric turbulence in the atmospheric condition during the observation time, into a state before the disturbance before being received by the receiving station 100B. Here, the conjugate wavefront (phase conjugate wave) means a wavefront of light spatially conjugate with respect to a wavefront of incident light (laser light immediately after being output from the laser light source 100A in FIG. 2).

For example, the control unit 13 receives, from the input unit 12, the observation data of the sunlight and the input data (observation condition) from the user terminal. The control unit 13 inputs the observation data of the sunlight and the observation condition input from the user terminal to the trained model 200 (FIG. 2).

As described above, the model 200 outputs wavefront data of the laser light predicted based on the observation data of the sunlight received from the receiving station 100B and the observation condition input from the user terminal.

The wavefront data of the laser light predicted from the observation data of the sunlight is a moving image of about several tens of seconds representing a pseudo wavefront of the laser light disturbed under the influence of the atmospheric turbulence. The model 200 outputs the wavefront data of the laser light predicted from the observation data of the sunlight to the controller 300.

The control unit 13 causes the controller 300 to control the adaptive optics (AO) 400 (FIG. 2) in such a way as to cancel the effect of the disturbance of the laser light due to the influence of the atmospheric turbulence based on the wavefront data of the laser light output from the trained model 200.

Specifically, the control unit 13 controls the adaptive optics 400 in such a way that a state of the laser light disturbed under the influence of the atmospheric turbulence, that is, the wavefront of the laser light incident on the receiving station 100B returns to a state immediately after being output from the transmitting station (laser light source) 100A, that is, the wavefront of the laser light before being affected by the atmospheric turbulence (FIG. 2).

### OPERATION OF OPTICAL SYSTEM CONTROL DEVICE 10

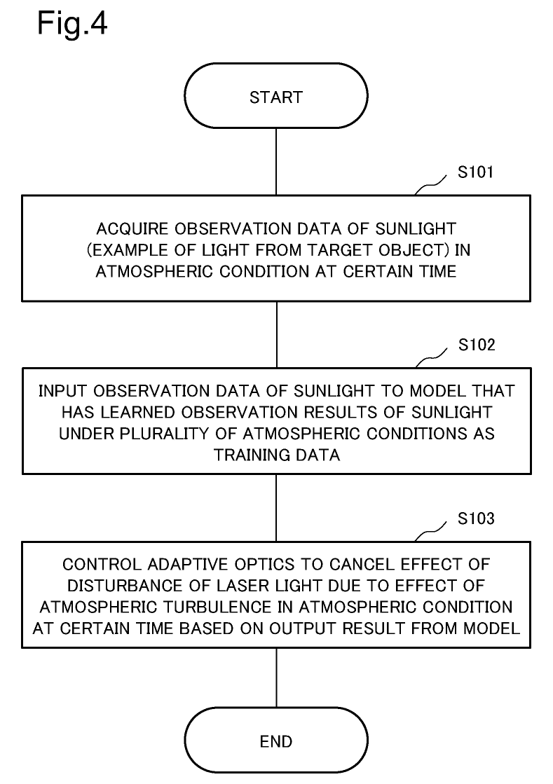

FIG. 4 illustrates an operation of the optical system control device 10 according to the first example embodiment. FIG. 4 is a flowchart illustrating the operation of the optical system control device 10.

As illustrated in FIG. 4, first, the acquisition unit 11 acquires observation data (FIG. 1) of sunlight in an atmospheric condition during an observation time from the receiving station 100B (FIGS. 1 and 2) (S101).

Next, the input unit 12 inputs observation data of the sunlight to the model 200 (FIGS. 1 and 2) that has learned observation results of the sunlight under a plurality of atmospheric conditions as training data (S102). The input unit 12 also inputs input data including an observation condition input from the user terminal (FIGS. 1 and 2) to the model 200, if any.

Thereafter, the control unit 13 controls the adaptive optics 400 (FIGS. 1 and 2) in such a way as to cancel an effect of disturbance of laser light due to an influence of atmospheric turbulence in the atmospheric condition during the observation time based on an output result from the model 200 (FIGS. 1 and 2) (S103).

As described above, the operation of the optical system control device 10 according to the first example embodiment ends.

### EFFECTS OF PRESENT EXAMPLE EMBODIMENT

According to the configuration of the present example embodiment, the acquisition unit 11 acquires observation data of sunlight in an atmospheric condition at a certain time (“observation time”). The input unit 12 inputs the observation data of the sunlight to the model 200 that has learned observation results of the sunlight under a plurality of atmospheric conditions as training data. Based on an output result from the model 200, the control unit 13 controls the adaptive optics 400 in such a way as to cancel an effect of disturbance of laser light due to an influence of atmospheric turbulence in the atmospheric condition at the certain time.

Even if the laser light is disturbed under the influence of the atmospheric turbulence, the influence of the atmospheric turbulence is canceled as the laser light passes through the adaptive optics 400. As a result, it is possible to reduce the disturbance of the laser light due to the influence of the atmospheric turbulence.

### SECOND EXAMPLE EMBODIMENT

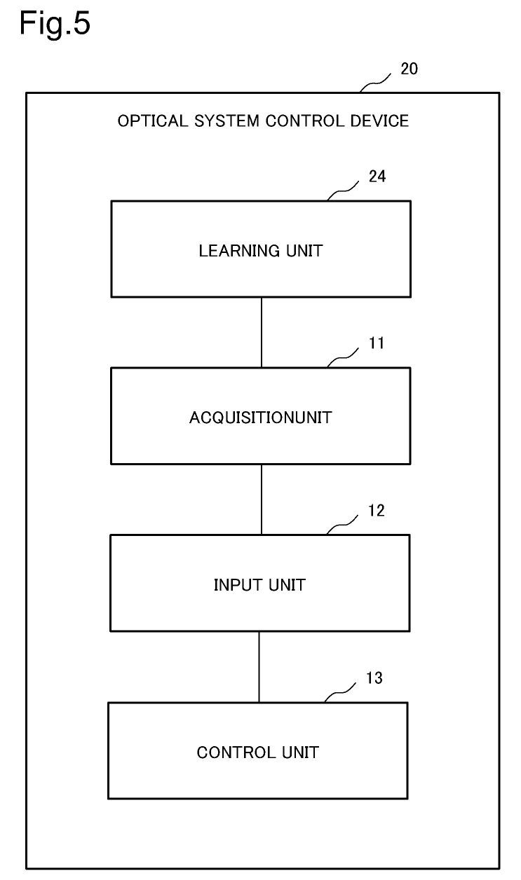

The second example embodiment of the present disclosure will be described with reference to FIGS. 5 to 9. In the second example embodiment, the same components as those in the first example embodiment are denoted by the same reference numerals as those in the first example embodiment, and the description thereof will be omitted.

### CONFIGURATION OF OPTICAL SYSTEM CONTROL DEVICE 20

FIG. 5 is a block diagram illustrating a configuration of the optical system control device 20 according to the second example embodiment. As illustrated in FIG. 5, the optical system control device 20 includes the acquisition unit 11, the input unit 12, and the control unit 13. The optical system control device 20 further includes a learning unit 24.

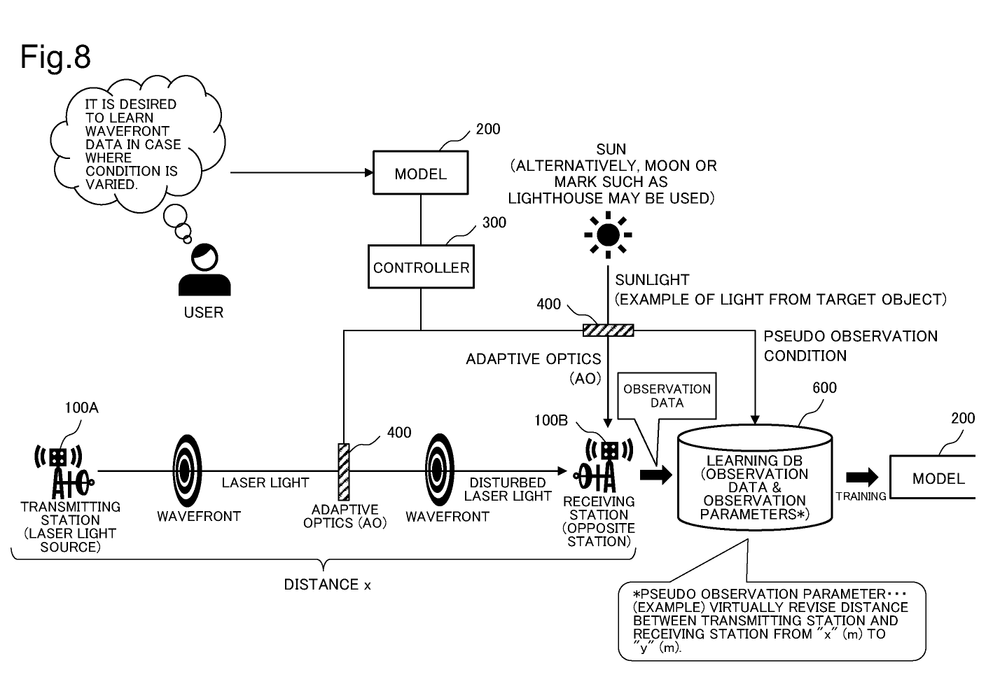

The learning unit 24 trains the model 200 (FIG. 8) by causing the model 200 of machine learning to learn observation results (a set of pieces of observation data) of sunlight and wavefront data of laser light observed under a plurality of atmospheric conditions. The learning unit 24 is an example of a learning means. Hereinafter, an example of a specific learning method of the model 200 will be described.

### EXAMPLE OF METHOD FOR TRAINING MODEL 200

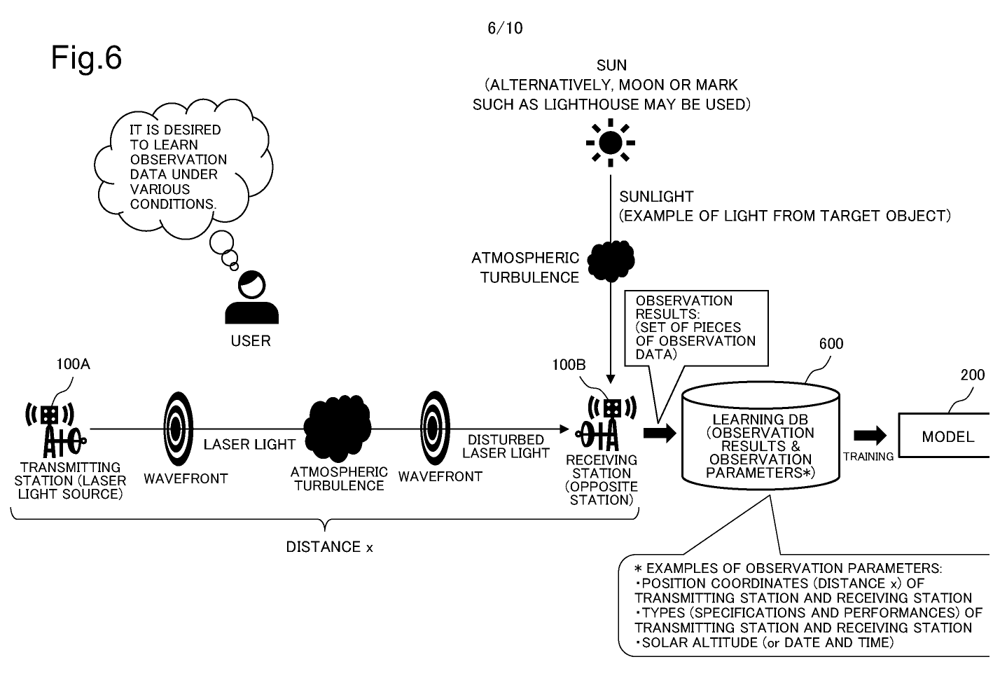

An example of a method in which the learning unit 24 of the optical system control device 20 trains the model 200 using training data will be described with reference to FIG. 6.

For example, the learning unit 24 acquires observation results (a set of pieces of observation data) of sunlight under a plurality of atmospheric conditions from a learning DB 600. In addition, the learning unit 24 also acquires, from the learning DB 600, wavefront data of laser light after disturbance (referred to as “disturbed laser light”) observed under the same observation conditions as the sunlight (the plurality of same atmospheric conditions).

Then, the learning unit 24 inputs the observation results of the sunlight acquired from the learning DB 600 and the wavefront data of the disturbed laser light to the model 200 as the training data. The learning unit 24 causes the model 200 to learn a relationship between the observation data of the sunlight (and the atmospheric condition represented by the observation data) and the wavefront data of the disturbed laser light.

In addition, the learning unit 24 may further input observation parameters representing the observation conditions under the plurality of atmospheric conditions to the model 200 to train the model 200.

### OPERATION OF OPTICAL SYSTEM CONTROL DEVICE 20

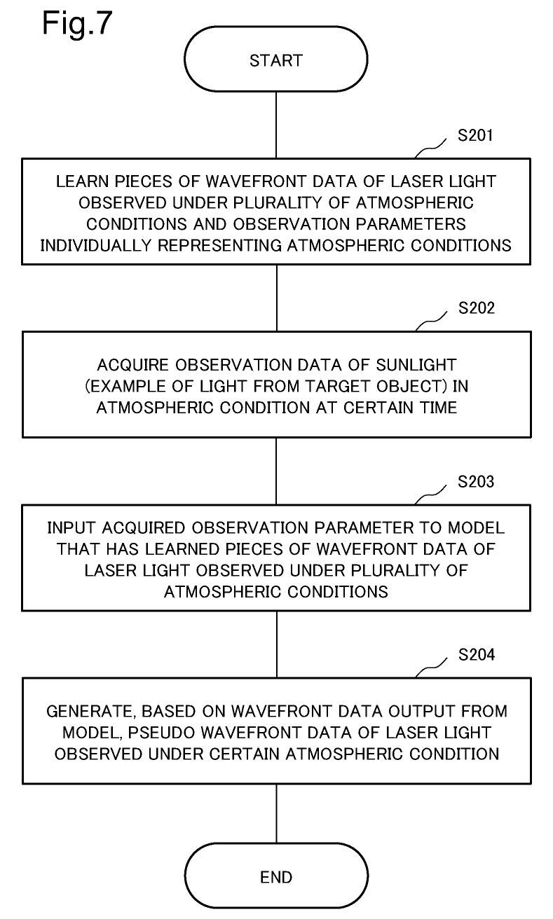

FIG. 7 illustrates an operation of the optical system control device 20 according to the second example embodiment. FIG. 7 is a flowchart illustrating the operation of the optical system control device 20.

As illustrated in FIG. 7, first, the learning unit 24 learns pieces of wavefront data (observation results) of laser light observed under a plurality of atmospheric conditions and observation parameters representing observation conditions under the plurality of atmospheric conditions (S201).

Next, the acquisition unit 11 acquires observation data of sunlight in an atmospheric condition at a certain time (“observation time”) (S202).

Subsequently, the input unit 12 inputs an observation parameter acquired by the acquisition unit 11 to the model 200 (FIG. 1) that has learned pieces of the wavefront data of the laser light observed under the plurality of atmospheric conditions (S203).

Thereafter, based on wavefront data output from the model 200, the control unit 13 generates pseudo wavefront data of the laser light observed under a certain atmospheric condition (S204).

As described above, the operation of the optical system control device 20 according to the second example embodiment ends.

### MODIFIED EXAMPLE

One modified example of the second example embodiment will be described with reference to FIG. 8. The present modified example considers a case where a user wants the model 200 to additionally learn wavefront data in a case where performances of the transmitting station 100A (FIG. 8) and the receiving station 100B (FIG. 8) or a condition such as an atmospheric condition is varied.

In the one modified example, the user determines an observation parameter representing a pseudo observation condition, and inputs the observation parameter to the optical system control device 20. For example, the pseudo observation condition is that a distance between the transmitting station 100A and the receiving station 100B is different from what the model 200 has learned so far. In an example, the user revises the distance between the transmitting station 100A and the receiving station 100B from the actual “x” (m) to a virtual “y” (m).

The learning unit 24 inputs the observation parameter representing the pseudo observation condition to the model 200, and causes the model 200 to learn pseudo wavefront data of disturbed laser light.

### FLOW OF ADDITIONAL LEARNING IN ONE MODIFIED EXAMPLE

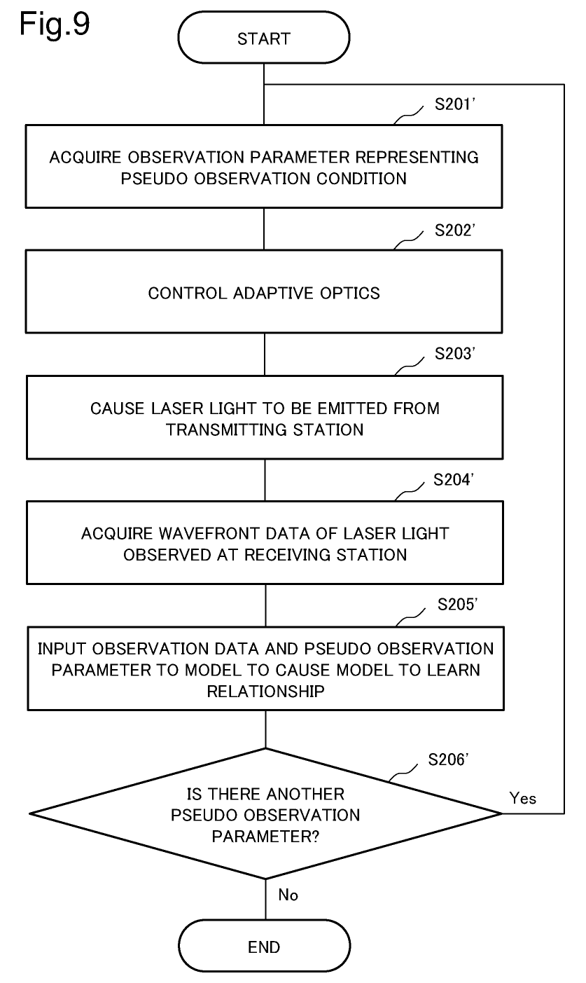

A flow of additional learning in the above-described one modified example will be described with reference to FIG. 9. FIG. 9 is a flowchart illustrating a flow of processing executed by the learning unit 24 (and a user) of the optical system control device 20.

First, the user sets an observation parameter representing a pseudo observation condition.

As illustrated in FIG. 9, the learning unit 24 acquires the observation parameter representing the pseudo observation condition (S201').

The learning unit 24 controls the adaptive optics 400 (FIG. 8) in accordance with the observation parameter representing the pseudo observation condition using the trained model 200 (S202').

The learning unit 24 causes laser light to be emitted from the transmitting station 100A (FIG. 8) (S203').

The learning unit 24 acquires wavefront data of the laser light observed at the receiving station 100B (FIG. 8) and observation data of sunlight (S204').

The learning unit 24 inputs the acquired wavefront data, the observation data, and the pseudo observation parameter to the model 200, and causes the model 200 to learn a relationship (S205').

Thereafter, an input of an observation parameter representing another pseudo observation condition is received from the user.

If the user desires to revise the pseudo observation parameter to the another pseudo observation parameter (Yes in S206'), the flow returns to step S201'.

On the other hand, if the user does not desire to revise the pseudo observation parameter to the another pseudo observation parameter (No in S206'), an operation of the learning unit 24 according to the present modified example ends.

### EFFECTS OF PRESENT EXAMPLE EMBODIMENT

According to the configuration of the present example embodiment, the learning unit 24 trains the model 200 by causing the model 200 of machine learning to learn pieces of observation data of sunlight and pieces of wavefront data of laser light observed under a plurality of atmospheric conditions. The acquisition unit 11 acquires observation data of the sunlight in an atmospheric condition at a certain time (“observation time”). The input unit 12 inputs the observation data of the sunlight to the model 200 that has learned observation results of the sunlight under a plurality of atmospheric conditions as training data. Based on an output result from the model 200, the control unit 13 controls the adaptive optics 400 in such a way as to cancel an effect of disturbance of laser light due to an influence of atmospheric turbulence in the atmospheric condition at the certain time.

Even if the laser light is disturbed under the influence of the atmospheric turbulence, the influence of the atmospheric turbulence is canceled as the laser light passes through the adaptive optics 400. As a result, it is possible to reduce the disturbance of the laser light due to the influence of the atmospheric turbulence.

### EXAMPLE OF HARDWARE CONFIGURATION

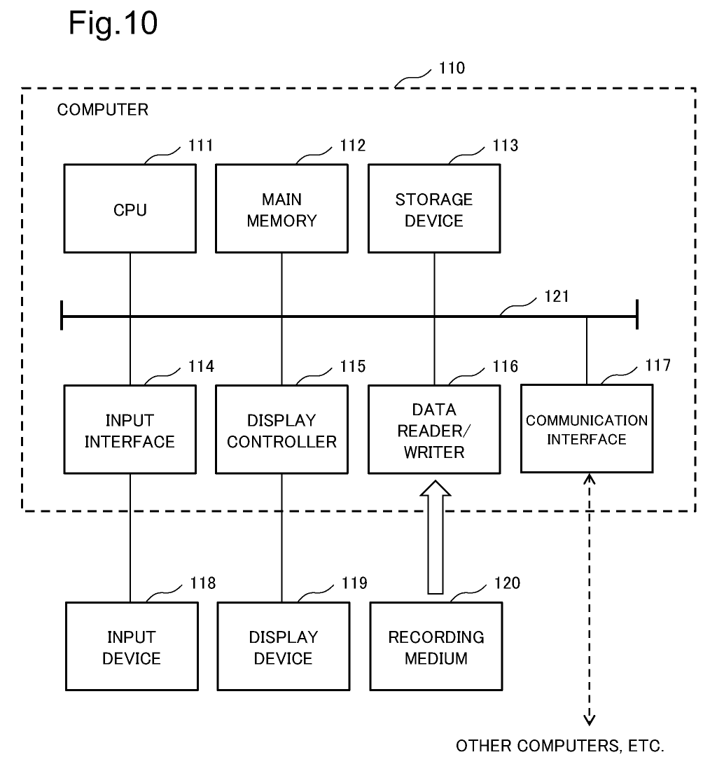

Each component of the optical system control devices 10 and 20 described in the first and second example embodiments represents a block of a functional unit. Some or all of these components are achieved by, for example, an information processing device as illustrated in FIG. 10. FIG. 10 is a block diagram illustrating an example of a hardware configuration of the information processing device.

As illustrated in FIG. 10, a computer 110 includes a central processing unit (CPU) 111, a main memory 112, a storage device 113, an input interface 114, a display controller 115, a data reader/writer 116, and a communication interface 117. These units are connected via a bus 121 in such a way as to be able to perform data communication with each other. The computer 110 may include a graphics processing unit (GPU) or a field-programmable gate array (FPGA) in addition to the CPU 111 or instead of the CPU 111.

The CPU 111 loads programs (codes) in the present example embodiment, which are stored in the storage device 113, into the main memory 112, and executes them in a predetermined order to perform various operations. The main memory 112 is typically a volatile storage device such as a dynamic random access memory (DRAM). The programs in the present example embodiment are provided in a state of being stored in a computer-readable recording medium 120. The programs in the present example embodiment may be distributed on the Internet connected via the communication interface 117.

Specific examples of the storage device 113 include a semiconductor storage device, such as a flash memory, in addition to a hard disk drive. The input interface 114 mediates data transmission between the CPU 111 and an input device 118 such as a keyboard and a mouse. The display controller 115 is connected to a display device 119 and controls display on the display device 119.

The data reader/writer 116 mediates data transmission between the CPU 111 and the recording medium 120, and reads a program from the recording medium 120 and writes a processing result of the computer 110 into the recording medium 120. The communication interface 117 mediates data transmission between the CPU 111 and another computer.

Specific examples of the recording medium 120 include a general-purpose semiconductor storage device such as Compact Flash (CF) (registered trademark) or Secure Digital (SD), a magnetic recording medium such as a flexible disk, and an optical recording medium such as a compact disk read only memory (CD-ROM).

### SUPPLEMENTARY NOTE

Some or all of the above example embodiments can also be described as the following Supplementary Notes, but are not limited to the following.

### Supplementary Note 1

An optical system control device including:

an acquisition means for acquiring observation data of light from a target object in an atmospheric condition at a certain time;

an input means for inputting the observation data of the light to a model that has learned observation results of the light under a plurality of the atmospheric conditions as training data; and

a control means for controlling adaptive optics in such a way as to cancel an effect of disturbance of laser light due to an influence of atmospheric turbulence in the atmospheric condition at the certain time based on an output result from the model.

### Supplementary Note 2

The optical system control device according to Supplementary Note 1, further including

a learning means for training the model by causing machine learning of the observation data of the light and wavefront data of the laser light observed under each of the plurality of atmospheric conditions.

### Supplementary Note 3

The optical system control device according to Supplementary Note 2, wherein

the learning means trains the model by further inputting an observation parameter representing an observation condition under each of the plurality of atmospheric conditions to the model.

### Supplementary Note 4

The optical system control device according to Supplementary Note 3, wherein

the observation parameter includes

at least one of

a distance between a transmitting station and a receiving station for the laser light,

types or performances of the transmitting station and the receiving station,

a solar altitude at an observation time, and

a date and time of the observation time.

### Supplementary Note 5

The optical system control device according to any one of Supplementary Notes 1 to 4, wherein

the control means controls the adaptive optics in such a way as to generate a phase conjugate wave of a wavefront of the laser light disturbed by the influence of the atmospheric turbulence in the atmospheric condition at the certain time based on the output result from the model.

### Supplementary Note 6

An optical system control method including:

a step of acquiring, by a computer, observation data of light from a target object in an atmospheric condition at a certain time;

a step of inputting, by the computer, the observation data of the light to a model that has learned observation results of the light under a plurality of the atmospheric conditions as training data; and

a step of controlling, by the computer, adaptive optics in such a way as to cancel an effect of disturbance of laser light due to an influence of atmospheric turbulence in the atmospheric condition at the certain time based on an output result from the model.

### Supplementary Note 7

The optical system control method according to Supplementary Note 6, further including

a step of training, by the computer, the model by causing machine learning of the observation data of the light and wavefront data of the laser light observed under each of the plurality of atmospheric conditions.

### Supplementary Note 8

The optical system control method according to Supplementary Note 7, wherein

the computer trains the model by further inputting an observation parameter representing an observation condition under each of the plurality of atmospheric conditions to the model.

### Supplementary Note 9

A program for causing a computer to execute:

processing of acquiring observation data of light from a target object in an atmospheric condition at a certain time;

processing of inputting the observation data of the light to a model that has learned observation results of the light under a plurality of the atmospheric conditions as training data; and

processing of controlling adaptive optics in such a way as to cancel an effect of disturbance of laser light due to an influence of atmospheric turbulence in the atmospheric condition at the certain time based on an output result from the model.

### Supplementary Note 10

The program according to Supplementary Note 9, further causing the computer to execute

processing of training the model by causing machine learning of the observation data of the light and wavefront data of the laser light observed under each of the plurality of atmospheric conditions.

### Supplementary Note 11

The program according to Supplementary Note 10, wherein

the computer is caused to execute the processing of training the model by further inputting an observation parameter representing an observation condition under each of the plurality of atmospheric conditions to the model.

Some or all of the configurations described in Supplementary Notes 2 to 5 dependent on Supplementary Note 1 described above (e.g. optical system control device) can also be dependent on Supplementary Note 6 (e.g. optical system control method) and Supplementary Note 9 (e.g. program) by the same dependency relationship as Supplementary Notes 2 to 5. Some or all of the configurations described as Supplementary Notes can be similarly dependent on various hardware, software, recording means for recording software, or systems without departing from the above-described example embodiments.

The present disclosure has been described above with reference to several example embodiments. However, the present disclosure is not limited to the above example embodiments. Each example embodiment can be appropriately combined with other example embodiments. Various modifications, which can be understood by those skilled in the art, can be made to the configuration and details of the above example embodiments within the scope of the present disclosure.

The present disclosure can be used to control a laser light source in a communication system, for example.

1. An optical system control device comprising:
a memory configured to store instructions; and
at least one processor configured to execute the instructions to perform:
acquiring observation data of light from a target object in an atmospheric condition at a certain time;
inputting the observation data of the light to a model that has learned observation results of the light under a plurality of the atmospheric conditions as training data; and
controlling adaptive optics in such a way as to cancel an effect of disturbance of laser light due to an influence of atmospheric turbulence in the atmospheric condition at the certain time based on an output result from the model.

2. The optical system control device according to claim 1, wherein
the at least one processor is further configured to execute the instructions to perform:
training the model by causing machine learning of the observation data of the light and wavefront data of the laser light observed under each of the plurality of atmospheric conditions.

3. The optical system control device according to claim 2, wherein
the at least one processor is configured to execute the instructions to perform:
training the model by further inputting an observation parameter representing an observation condition under each of the plurality of atmospheric conditions to the model.

4. The optical system control device according to claim 3, wherein
the observation parameter includes
at least one of
a distance between a transmitting station and a receiving station for the laser light,
types or performances of the transmitting station and the receiving station,
a solar altitude at an observation time, and
a date and time of the observation time.

5. The optical system control device according to claim 1, wherein
the at least one processor is configured to execute the instructions to perform:
controlling the adaptive optics in such a way as to generate a phase conjugate wave of a wavefront of the laser light disturbed by the influence of the atmospheric turbulence in the atmospheric condition at the certain time based on the output result from the model.

6. An optical system control method comprising:
a step of acquiring, by a computer, observation data of light from a target object in an atmospheric condition at a certain time;
a step of inputting, by the computer, the observation data of the light to a model that has learned observation results of the light under a plurality of the atmospheric conditions as training data; and
a step of controlling, by the computer, adaptive optics in such a way as to cancel an effect of disturbance of laser light due to an influence of atmospheric turbulence in the atmospheric condition at the certain time based on an output result from the model.

7. The optical system control method according to claim 6, further comprising
a step of training, by the computer, the model by causing machine learning of the observation data of the light and wavefront data of the laser light observed under each of the plurality of atmospheric conditions.

8. The optical system control method according to claim 7, wherein
the computer trains the model by further inputting an observation parameter representing an observation condition under each of the plurality of atmospheric conditions to the model.

9. The optical system control method according to claim 8, wherein
the observation parameter includes
at least one of
a distance between a transmitting station and a receiving station for the laser light,
types or performances of the transmitting station and the receiving station,
a solar altitude at an observation time, and
a date and time of the observation time.

10. The optical system control method according to claim 6, wherein
the computer controls the adaptive optics in such a way as to generate a phase conjugate wave of a wavefront of the laser light disturbed by the influence of the atmospheric turbulence in the atmospheric condition at the certain time based on the output result from the model.

11. A non-transitory recording medium storing a program for causing a computer to execute:
processing of acquiring observation data of light from a target object in an atmospheric condition at a certain time;
processing of inputting the observation data of the light to a model that has learned observation results of the light under a plurality of the atmospheric conditions as training data; and
processing of controlling adaptive optics in such a way as to cancel an effect of disturbance of laser light due to an influence of atmospheric turbulence in the atmospheric condition at the certain time based on an output result from the model.

12. The recording medium according to claim 11, wherein
the program causes the computer to further execute
processing of training the model by causing machine learning of the observation data of the light and wavefront data of the laser light observed under each of the plurality of atmospheric conditions.

13. The recording medium according to claim 12, wherein
the program causes the computer to further execute
training the model by further inputting an observation parameter representing an observation condition under each of the plurality of atmospheric conditions to the model.

14. The recording medium according to claim 13, wherein
the observation parameter includes
at least one of
a distance between a transmitting station and a receiving station for the laser light,
types or performances of the transmitting station and the receiving station,
a solar altitude at an observation time, and
a date and time of the observation time.

15. The recording medium according to claim 11, wherein
the program causes the computer to execute
controlling the adaptive optics in such a way as to generate a phase conjugate wave of a wavefront of the laser light disturbed by the influence of the atmospheric turbulence in the atmospheric condition at the certain time based on the output result from the model.
